(19) United States
(12) Patent Application Publication
(10) Pub. No.: US 2025/0033631 A1
(43) Pub. Date: Jan. 30, 2025

(54) SECONDARY COLLISION AVOIDANCE CONTROL METHOD OF AUTONOMOUS VEHICLE

(71) Applicants: Hyundai Motor Company, Seoul (KR); Kia Corporation, Seoul (KR)

(72) Inventors: In Su Kim, Anyang (KR); Myung Ki Yeom, Incheon (KR)

(21) Appl. No.: 18/520,085

(22) Filed: Nov. 27, 2023

(30) Foreign Application Priority Data
Jul. 25, 2023 (KR) 10-2023-0096483

(51) Int. Cl. B60W 30/09; B60W 10/18; B60W 10/20; B60W 30/095; B60W 60/00

(52) U.S. Cl. CPC B60W 30/09; B60W 10/18; B60W 10/20; B60W 30/0953; B60W 30/0956; B60W 60/0015; B60W 2420/54; B60W 2520/105; B60W 2520/125; B60W 2520/14; B60W 2556/65

(57) ABSTRACT

A secondary collision avoidance control method of an autonomous vehicle includes: selecting, by an autonomous driving controller, a collision candidate vehicle based on sensor signals, estimating, by the autonomous driving controller, a moving path of the autonomous vehicle using the sensor signals, upon determining that collision of the autonomous vehicle with the collision candidate vehicle occurs, estimating, by the autonomous driving controller, secondary collision occurrence probabilities of the autonomous vehicle with the other vehicles, upon determining that the autonomous vehicle breaches an adjacent lane, confirming, by the autonomous driving controller, positions of additional collision candidate vehicles traveling in the lane breached by the autonomous vehicle, and calculating safety distances between the autonomous vehicle and the additional collision candidate vehicles, and controlling, by the autonomous driving controller, steering, driving torque, and braking torque of the autonomous vehicle so as to move the autonomous vehicle to a virtual safety area.

### CROSS-REFERENCE TO RELATED APPLICATION

This application claims under 35 U.S.C. § 119 (a) the benefit of Korean Patent Application No. 10-2023-0096483 filed on Jul. 25, 2023, the entire contents of which are incorporated herein by reference.

### BACKGROUND

### (a) Technical Field

The present disclosure relates to a secondary collision avoidance control method of an autonomous vehicle, more particularly, to the secondary collision avoidance control method of the autonomous vehicle that is configured to minimize injury to a driver even in an abnormal driving state of the autonomous vehicle due to a side collision, or the like.

### (b) Description of the Related Art

According to recent highway traffic accident statistics, approximately 14% of all deaths are caused by secondary collisions, and the fatality rate due to secondary collisions is about 50%, i.e., is 3.3 times higher than the average fatality rate of 15.3% for all traffic accidents.

The reason why the fatality rate for secondary collisions is high is that damage due to secondary collisions is added to damage due to primary collisions, and thus the extent of damage is increased.

Therefore, in an effort to reduce deaths from traffic accidents due to secondary collisions, research on secondary collision avoidance systems has been actively conducted since about 2010.

Most of the conventional secondary collision avoidance systems were devised based on post-control in which vehicle stability is secured through steering and braking cooperative control after a primary collision.

However, in securing vehicle stability through post-control, there are two limitations as described below.

First, due to a possibility that sensors and actuators become damaged and malfunction, most sensors used to control behavior of vehicles employ devices vulnerable to impact, and there is a high possibility that the sensors cannot function normally after a primary collision.

Further, most actuators used to control steering and braking of vehicles are electric actuators, and there is a high possibility that the actuators become damaged and malfunction due to disconnection and short circuit of a controller due to impact.

Second, it is difficult to anticipate which steering and braking input a driver will apply after a primary collision due to uncertainty in a driving pattern of the driver immediately after the primary collision, and when the driving pattern of the driver and the steering and braking input based on post-control conflict with each other, vehicle stability may be deteriorated and may thus cause a more serious secondary accident.

The above information disclosed in this Background section is only for enhancement of understanding of the background of the disclosure and therefore it may contain information that does not form the prior art that is already known in this country to a person of ordinary skill in the art.

### SUMMARY

The present disclosure provides a secondary collision avoidance control method of an autonomous vehicle which, in order to prevent occurrence of a secondary collision of the autonomous vehicle after a side collision with a surrounding vehicle during autonomous driving, surrounding vehicles traveling on a moving path in a lane breached by the autonomous vehicle are notified of the risk of secondary collision, a safety area is secured by inducing changes in the traveling positions of the surrounding vehicles on the moving path of the autonomous vehicle by requesting acceleration or deceleration from the surrounding vehicles so as to move the autonomous vehicle to the secured safety area without secondary collision occurrence, and thus, the secondary collision of the autonomous vehicle is prevented so as to minimize injury to a driver due to collision.

In one aspect, the present disclosure provides a secondary collision avoidance control method of an autonomous vehicle, including selecting, by an autonomous driving controller, a collision candidate vehicle configured to be collidable with the autonomous vehicle from among other vehicles based on a plurality of sensor signals from an autonomous driving sensor unit, estimating, by the autonomous driving controller, a moving path of the autonomous vehicle using the sensor signals detected from the autonomous driving sensor unit, upon determining that the collision candidate vehicle approaches and collision of the autonomous vehicle with the collision candidate vehicle occurs, estimating, by the autonomous driving controller, secondary collision occurrence probabilities of the autonomous vehicle with the other vehicles, upon determining that the autonomous vehicle breaches an adjacent lane based on the estimated moving path, confirming, by the autonomous driving controller, positions of additional collision candidate vehicles traveling in front of or behind the autonomous vehicle and configured to be collidable with the autonomous vehicle among other vehicles traveling in the lane breached by the autonomous vehicle, and calculating safety distances between the autonomous vehicle and the additional collision candidate vehicles based on the sensor signals from the autonomous sensor unit, and controlling, by the autonomous driving controller, steering, driving torque, and braking torque of the autonomous vehicle so as to move the autonomous vehicle to a virtual safety area, when the safety area is formed by securing the safety distances between the autonomous vehicle and the additional collision candidate vehicles traveling in front of or behind the autonomous vehicle.

In a preferred embodiment, in estimating, by the autonomous driving controller, the moving path of the autonomous vehicle, the autonomous driving controller may compare measurement values of the sensor signals with set limit values, and may estimate the moving path of the autonomous vehicle through the sensor signals including a longitudinal acceleration, a lateral acceleration, and a yaw rate detected by the autonomous driving sensor unit. upon determining that the collision of the autonomous vehicle with the candidate vehicle occurs.

In another preferred embodiment, in estimating, by the autonomous driving controller, the moving path of the autonomous vehicle, the autonomous driving controller may estimate relative positions of the autonomous vehicle to the other vehicles after occurrence of primary collision through sensor signals detected by a camera, an around view monitor, and a distance sensor other than an acceleration sensor and a yaw rate sensor configured to detect the longitudinal acceleration, the lateral acceleration, and the yaw rate, upon determining that the measurement values of the sensor signals exceed the limit values.

In still another preferred embodiment, in estimating, by the autonomous driving controller, the secondary collision occurrence probabilities of the autonomous vehicle with the other vehicles, the autonomous driving controller may request cooperative control from other vehicles traveling in a lane, in which the autonomous vehicle is currently traveling, upon determining that the autonomous vehicle breaches no adjacent lane based on the estimated moving path.

In yet another preferred embodiment, in estimating, by the autonomous driving controller, the secondary collision occurrence probabilities of the autonomous vehicle with the other vehicles, the autonomous driving controller may request cooperative control of acceleration from a vehicle traveling in front of the autonomous vehicle in the lane, in which the autonomous vehicle is currently traveling, upon determining that a speed of the autonomous vehicle is increased through the autonomous driving sensor unit, and may request cooperative control of acceleration from a vehicle traveling behind the autonomous vehicle in the lane, in which the autonomous vehicle is currently traveling, upon determining that the speed of the autonomous vehicle is decreased through the autonomous driving sensor unit.

In still yet another preferred embodiment, in estimating, by the autonomous driving controller, the secondary collision occurrence probabilities of the autonomous vehicle with the other vehicles, the autonomous driving controller may request cooperative control from the other vehicles in real time using at least one of Internet Of Things (IoT), Vehicle-to-Vehicle (V2V) communication, a RADAR system, a LIDAR system, ultrasonic waves, a camera, or a navigation system.

In a further preferred embodiment, in controlling, by the autonomous driving controller, the steering, the driving torque, and the braking torque of the autonomous vehicle so as to move the autonomous vehicle to the safety area, the autonomous driving controller may request cooperative control of acceleration from a vehicle traveling in front of the autonomous vehicle in the lane breached by the autonomous vehicle, and may request cooperative control of deceleration from a vehicle traveling behind the autonomous vehicle in the lane breached by the autonomous vehicle, upon determining that the other vehicles are located at front and rear boundary regions of the safety area.

In another further preferred embodiment, in controlling, by the autonomous driving controller, the steering, the driving torque, and the braking torque of the autonomous vehicle so as to move the autonomous vehicle to the safety area, the autonomous driving controller may request cooperative control from the other vehicles in real time using at least one of Internet Of Things (IoT), Vehicle-to-Vehicle (V2V) communication, a RADAR system, a LIDAR system, ultrasonic waves, a camera, or a navigation system.

In still another further preferred embodiment, in controlling, by the autonomous driving controller, the steering, the driving torque, and the braking torque of the autonomous vehicle so as to move the autonomous vehicle to the safety area, the autonomous driving controller may request cooperative control of acceleration from a vehicle traveling in front of the autonomous vehicle in the lane breached by the autonomous vehicle, and may request cooperative control of deceleration from a vehicle traveling behind the autonomous vehicle in the lane breached by the autonomous vehicle before moving the autonomous vehicle to the safety area, upon determining that the safety distances between the autonomous vehicle and the additional collision candidate vehicles are not secured.

In yet another further preferred embodiment, in controlling, by the autonomous driving controller, the steering, the driving torque, and the braking torque of the autonomous vehicle so as to move the autonomous vehicle to the safety area, the autonomous driving controller may selectively change the safety area, upon determining that the cooperative control from the vehicle traveling behind the autonomous vehicle in the lane breached by the autonomous vehicle is not enabled.

In still yet another further preferred embodiment, in controlling, by the autonomous driving controller, the steering, the driving torque, and the braking torque of the autonomous vehicle so as to move the autonomous vehicle to the safety area, the autonomous driving controller may change the safety area to move the safety area forwards.

In a still further preferred embodiment, in controlling, by the autonomous driving controller, the steering, the driving torque, and the braking torque of the autonomous vehicle so as to move the autonomous vehicle to the safety area, the autonomous driving controller may selectively change the safety area, upon determining that the cooperative control of deceleration from the vehicle traveling in front of the autonomous vehicle in the lane breached by the autonomous vehicle is not enabled.

In a yet still further preferred embodiment, in controlling, by the autonomous driving controller, the steering, the driving torque, and the braking torque of the autonomous vehicle so as to move the autonomous vehicle to the safety area, the autonomous driving controller may change the safety area to move the safety area rearwards.

A vehicle may include an autonomous driving controller for carrying out the secondary collision avoidance control method.

An autonomous vehicle may include the autonomous driving controller for carrying out the secondary collision avoidance control method.

A non-transitory computer readable medium containing program instructions executed by a processor may include: program instructions that select a collision candidate vehicle configured to be collidable with an autonomous vehicle from among other vehicles based on a plurality of sensor signals from an autonomous driving sensor unit; program instructions that estimate a moving path of the autonomous vehicle using the sensor signals detected from the autonomous driving sensor unit, upon determining that the collision candidate vehicle approaches and collision of the autonomous vehicle with the collision candidate vehicle occurs; program instructions that estimate secondary collision occurrence probabilities of the autonomous vehicle with the other vehicles, upon determining that the autonomous vehicle breaches an adjacent lane based on the estimated moving path; program instructions that confirm positions of additional collision candidate vehicles traveling in front of or behind the autonomous vehicle and configured to be collidable with the autonomous vehicle among the other vehicles traveling in the lane breached by the autonomous vehicle, and calculating safety distances between the autonomous vehicle and the additional collision candidate vehicles based on the sensor signals from the autonomous sensor unit; and program instructions that control steering, driving torque, and braking torque of the autonomous vehicle so as to move the autonomous vehicle to a virtual safety area, when the safety area is formed by securing the safety distances between the autonomous vehicle and the additional collision candidate vehicles traveling in front of or behind the autonomous vehicle.

Other aspects and preferred embodiments of the disclosure are discussed infra.

The above and other features of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given herein below by way of illustration only, and thus are not limitative of the present disclosure, and wherein:

FIGS. 1 and 2 are control block diagrams illustrating a secondary collision avoidance control method of an autonomous vehicle according to one embodiment of the present disclosure;

FIGS. 3A to 3C are schematic views showing examples of occurrence of secondary collision so as to illustrate the secondary collision avoidance control method according to one embodiment of the present disclosure;

FIG. 4 is a flowchart representing the secondary collision avoidance control method according to one embodiment of the present disclosure;

FIG. 5 is a flowchart representing a first embodiment of movement of the autonomous vehicle to a safety area in the secondary collision avoidance control method according to one embodiment of the present disclosure;

FIG. 6 is a schematic view illustrating the first embodiment of the movement of the autonomous vehicle to the safety area in the secondary collision avoidance control method according to one embodiment of the present disclosure;

FIG. 7 is a flowchart representing a second embodiment of the movement of the autonomous vehicle to the safety area in the secondary collision avoidance control method according to one embodiment of the present disclosure;

FIG. 8 is a schematic view illustrating the second embodiment of the movement of the autonomous vehicle to the safety area in the secondary collision avoidance control method according to one embodiment of the present disclosure;

FIG. 9 is a schematic view illustrating change in the safety area in the secondary collision avoidance control method according to one embodiment of the present disclosure; and

FIG. 10 is a graph representing comparison between a limit value of a yaw rate sensor and an actual value of the yaw rate sensor in the secondary collision avoidance control method according to one embodiment of the present disclosure.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, reference will be made in detail to various embodiments of the present disclosure, examples of which are illustrated in the accompanying drawings and described below.

Advantages and features of the present disclosure and methods for achieving the same will become apparent from the descriptions of the embodiments herein below with reference to the accompanying drawings.

However, the present disclosure is not limited to the embodiments disclosed herein and may be implemented in various different forms, and these embodiments are provided to make the description of the present disclosure thorough and to fully convey the scope of the present disclosure to those skilled in the art. It is to be noted that the scope of the present disclosure is defined only by the claims.

Further, in the following description of the present disclosure, a detailed description of known functions and configurations incorporated herein will be omitted when it may make the subject matter of the present disclosure rather unclear.

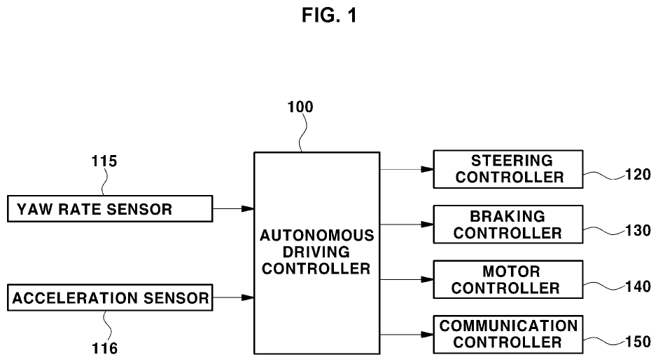

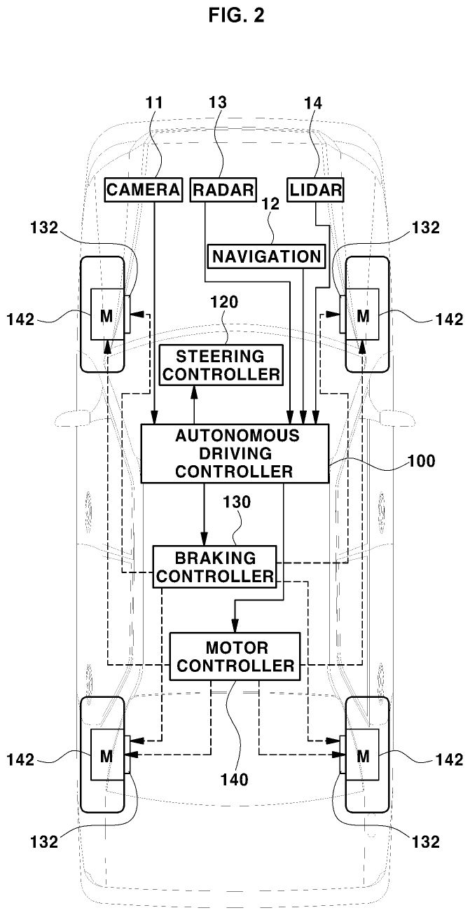

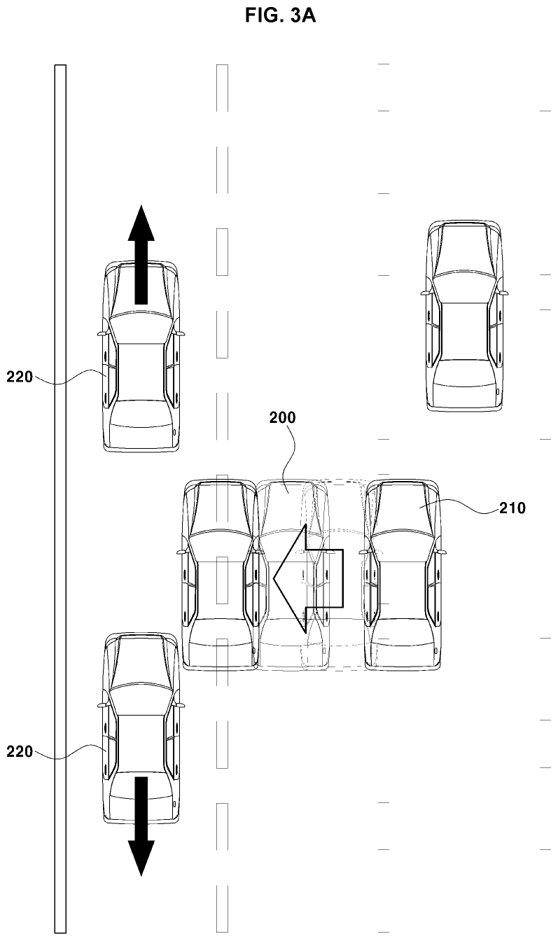

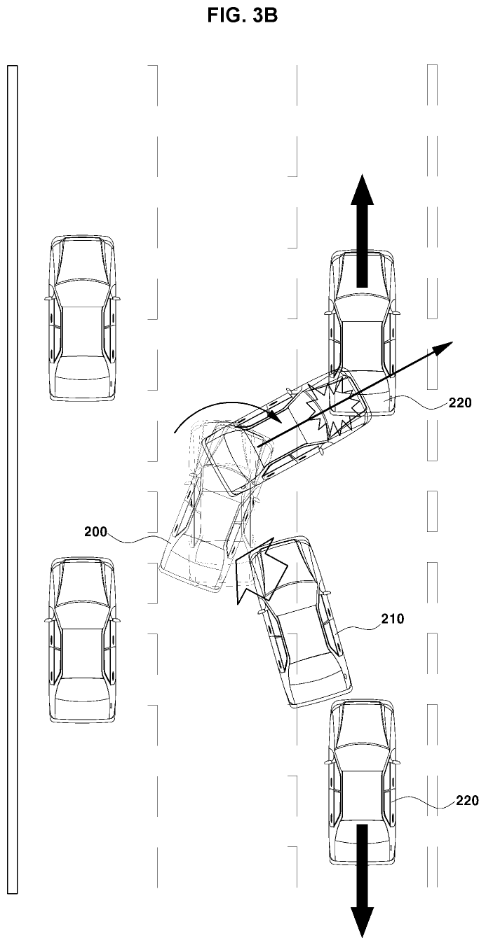

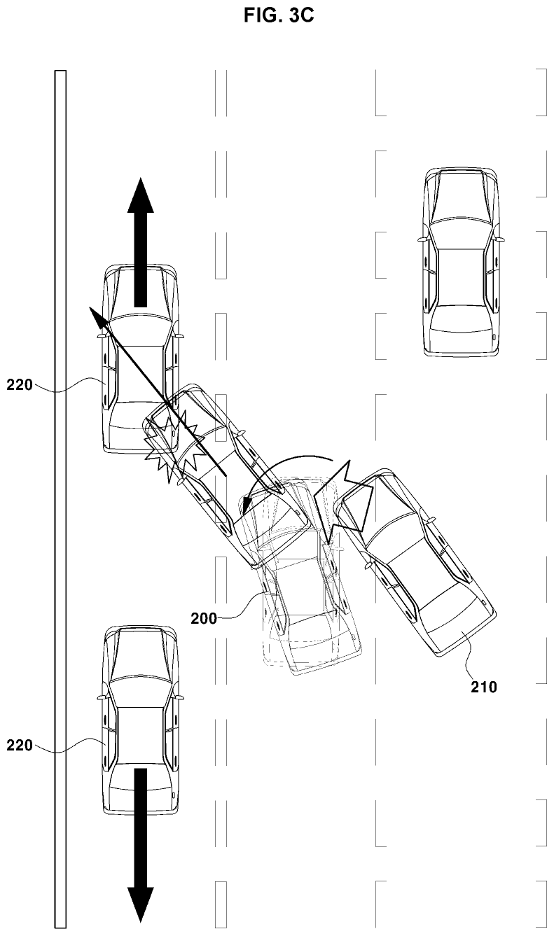

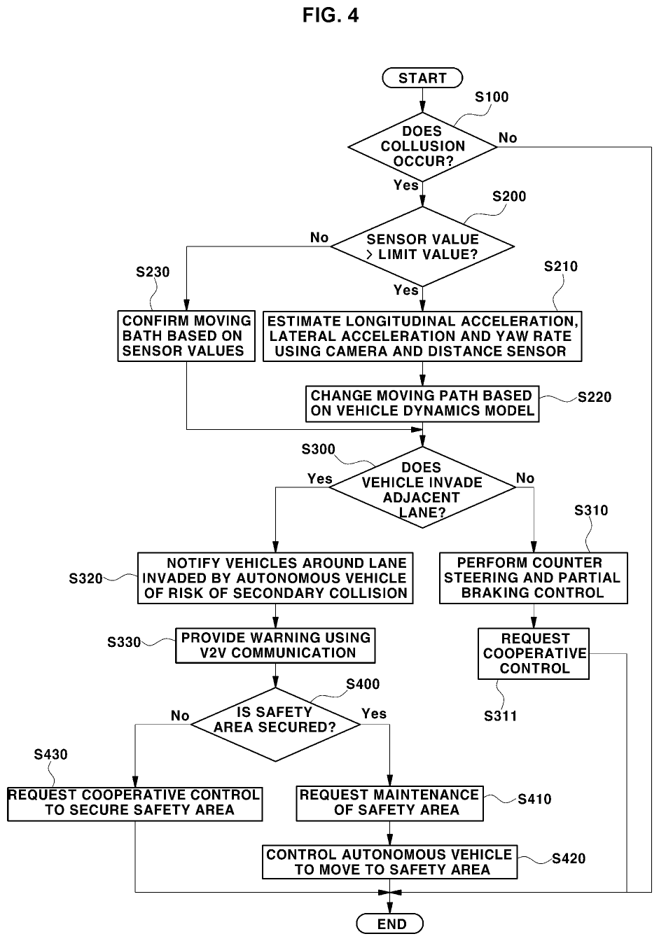

FIGS. 1 and 2 are control block diagrams illustrating a secondary collision avoidance control method of an autonomous vehicle according to one embodiment of the present disclosure, FIGS. 3A to 3C are schematic views showing examples of occurrence of secondary collision so as to illustrate the secondary collision avoidance control method according to one embodiment of the present disclosure, and FIG. 4 is a flowchart representing the secondary collision avoidance control method according to one embodiment of the present disclosure.

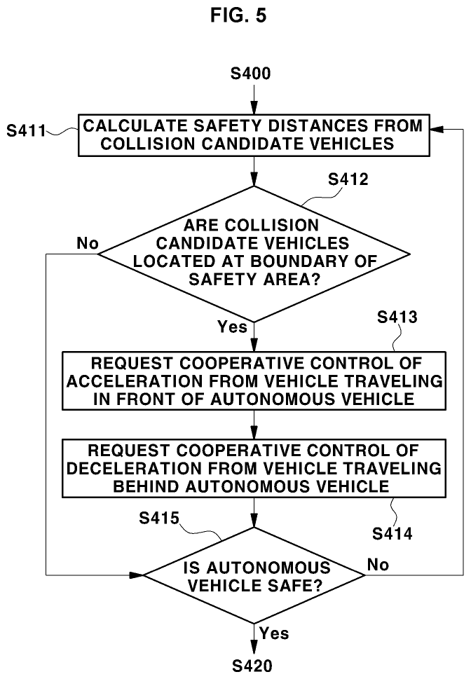

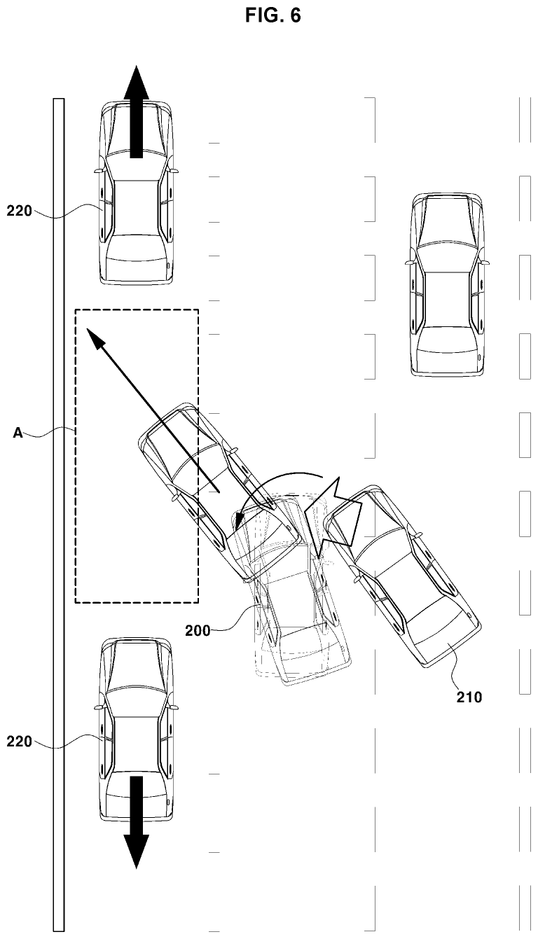

Further, FIG. 5 is a flowchart representing a first embodiment of movement of the autonomous vehicle to a safety area in the secondary collision avoidance control method according to one embodiment of the present disclosure, and FIG. 6 is a schematic view illustrating the first embodiment of the movement of the autonomous vehicle to the safety area in the secondary collision avoidance control method according to one embodiment of the present disclosure.

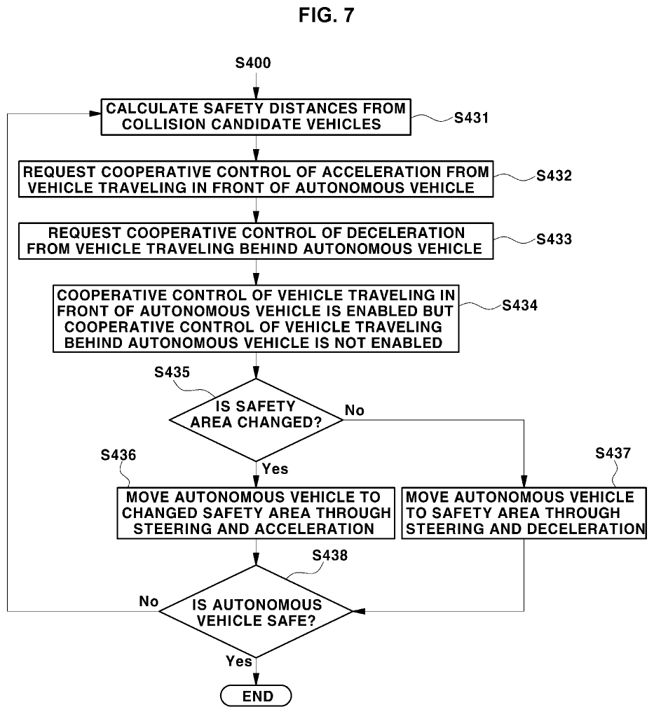

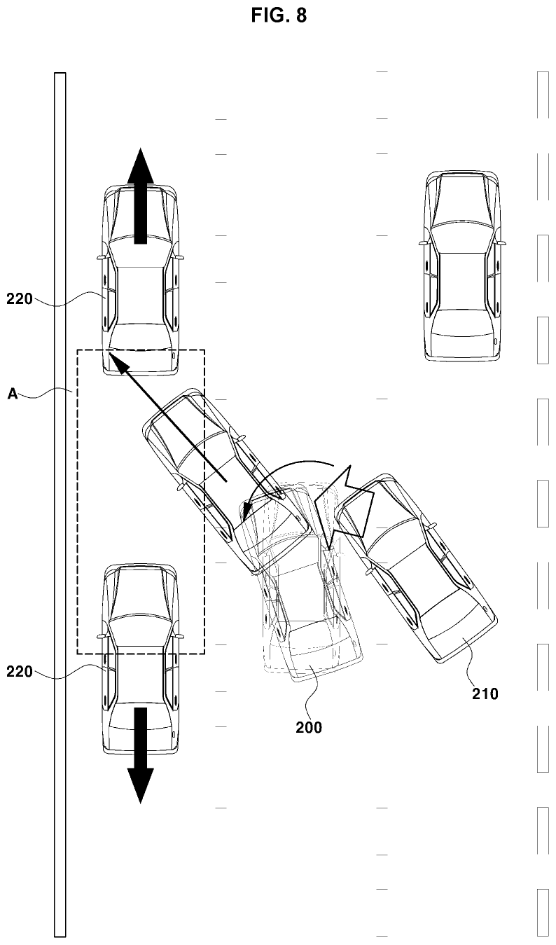

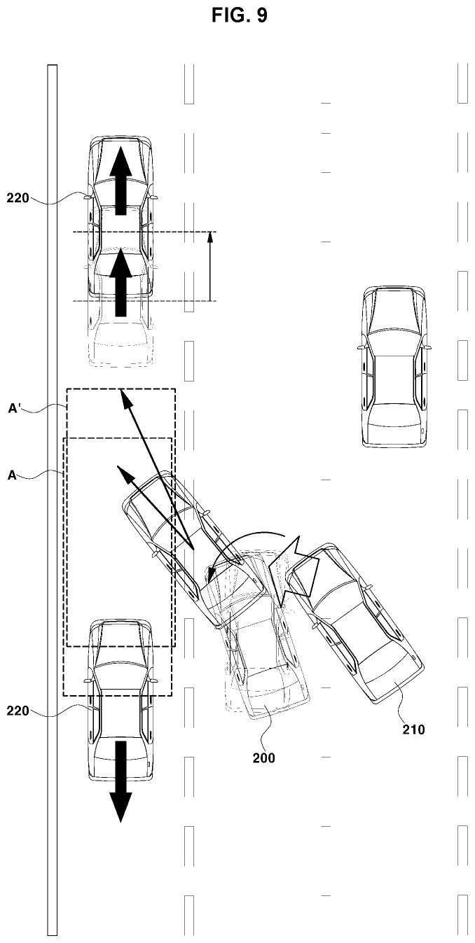

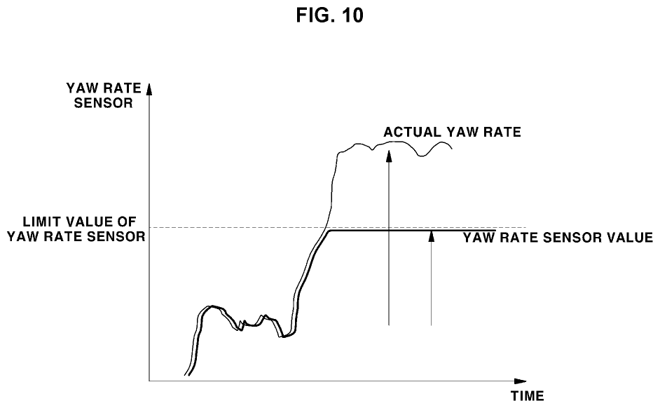

In addition, FIG. 7 is a flowchart representing a second embodiment of the movement of the autonomous vehicle to the safety area in the secondary collision avoidance control method according to one embodiment of the present disclosure, FIG. 8 is a schematic view illustrating the second embodiment of the movement of the autonomous vehicle to the safety area in the secondary collision avoidance control method according to one embodiment of the present disclosure, and FIG. 9 is a schematic view illustrating change in the safety area in the secondary collision avoidance control method according to one embodiment of the present disclosure.

In a fully autonomous vehicle or system, the vehicle may perform all driving tasks under all conditions and little or no driving assistance is required a human driver. In semi-autonomous vehicle, for example, the automated driving system may perform some or all parts of the driving task in some conditions, but a human driver regains control under some conditions, or in other semi-autonomous systems, the vehicle's automated system may oversee steering and accelerating and braking in some conditions, although the human driver is required to continue paying attention to the driving environment throughout the journey, while also performing the remainder of the necessary tasks. In certain embodiments, the present systems and vehicles may be fully autonomous. In other certain embodiments, the present systems and vehicles may be semi-autonomous.

As provided herein, an autonomous driving controller 100 may constitute hardware components that form part of the controller (e.g., modules or devices of the controller), or may constitute individual controllers each having a processor and memory. The autonomous driving controller 100 may include one or more processors and memory.

As shown in FIG. 1, the autonomous driving controller 100 configured to control overall autonomous driving is mounted in an autonomous vehicle, and a yaw rate sensor 115 and an acceleration sensor 116 are connected to an input interface of the autonomous driving controller 100 so as to enable signal transmission therebetween.

A steering controller 120 configured to control steering, a braking controller 130 configured to control braking torque, a motor controller 140 configured to control driving torque, and a communication controller 150 configured to achieve vehicle-to-vehicle communication are connected to an output interface of the autonomous driving controller 100 so as to enable command signal reception.

Secondary collision avoidance control refers to a series of control procedures of monitoring other vehicles and obstacles around a driving ego vehicle, selecting a vehicle collidable with the ego vehicle from among the monitored vehicles, and moving the ego vehicle to an avoidance area in which the ego vehicle may avoid secondary collision using steering control, the driving torque, the braking torque, and the like in the event of collision with the selected vehicle.

As shown in FIG. 2, the autonomous driving controller 100 is configured to receive various monitoring information required for autonomous driving from an autonomous driving sensor unit including a camera 11, a navigation system 12, and a distance sensor including a Radio Detection and Ranging (RADAR) system 13 or a Light Imaging Detection and Ranging (LIDAR) system 14, which are basically mounted in the autonomous vehicle, and to control overall autonomous driving including the driving direction of the autonomous vehicle and the acceleration and deceleration control of the autonomous vehicle based on the monitoring information.

Therefore, in order to perform secondary collision avoidance control during driving of the autonomous vehicle, the autonomous driving sensor unit, including the camera 11, the navigation system 12, and the distance sensor including the RADAR system 13 or the LIDAR system 14, may monitor other vehicles and obstacles around the autonomous vehicle depending on a command from the autonomous driving controller 100.

The autonomous driving controller 100 is configured to receive signals obtained by monitoring other vehicles and obstacles around the autonomous vehicle from the autonomous driving sensor unit, including the camera 11, the navigation system 12, and the distance sensor including the RADAR system 13 or the LIDAR system 14, and to select a collision candidate vehicle collidable with the autonomous vehicle among the vehicles around the autonomous vehicle based on the received signals, in order to perform secondary collision avoidance control.

For this purpose, the autonomous driving controller 100 confirms whether or not a vehicle approaching the autonomous vehicle within a designated radius is present based on the sensor signals received from the autonomous driving sensor unit, and calculates a collision index indicating a possibility of collision with the vehicle approaching the autonomous vehicle within the designated radius, when it is confirmed that the vehicle approaching the autonomous vehicle within the designated radius is present.

Thereby, the corresponding vehicle may be selected as the collision candidate vehicle collidable with the autonomous vehicle when the calculated collision index of the vehicle exceeds a reference value, and may be excluded from the collision candidate vehicle when the calculated collision index of the vehicle is equal to or less than the reference value.

The above-described process of calculating the collision index of the vehicle will be described in detail below.

The autonomous driving controller 100 is configured to calculate an angular velocity of rotation (yaw rate), a longitudinal acceleration, and a lateral acceleration of the vehicle, which are state variables, using a driving speed of the collision candidate vehicle selected through the sensor signals received from the autonomous driving sensor unit, a collision angle when the collision candidate vehicle approaches the autonomous vehicle and collides with the autonomous vehicle, a longitudinal relative distance and a lateral relative distance of the autonomous vehicle from the collision candidate vehicle, etc., and to estimate in advance a moving position change of the autonomous vehicle due to a virtual collision with the collision candidate vehicle using the calculated yaw rate, longitudinal acceleration, and lateral acceleration of the autonomous vehicle.

In addition, the autonomous driving controller 100 is configured to estimate in advance the moving position change of the autonomous vehicle due to the virtual collision with the vehicle selected as the collision candidate vehicle based on various collision test result data of vehicles.

However, the above-estimated moving position change of the autonomous vehicle due to the virtual collision with the vehicle selected as the collision candidate vehicle may be different from an actual moving position change of the vehicle due to an actual collision accident with the vehicle, and may thus be inaccurate.

Therefore, the autonomous driving controller 100 is configured to receive a yaw rate signal detected by the yaw rate sensor 115 of the autonomous vehicle and a longitudinal acceleration signal and a lateral acceleration signal detected by the acceleration sensor 116 of the autonomous vehicle when the autonomous vehicle actually collides with the vehicle, and to correct the estimated moving position change of the autonomous vehicle due to the virtual collision with the vehicle so as to fit a moving position change of the autonomous vehicle due to an actual collision accident.

Further, the autonomous driving controller 100 is configured to determine a secondary collision occurrence probability that the autonomous vehicle secondarily collides with a vehicle or an obstacle around the autonomous vehicle.

For example, when a vehicle or an obstacle is present in the corrected moving position of the autonomous vehicle, the autonomous driving controller 100 may determine that secondary collision of the autonomous vehicle with the vehicle and the obstacle will occur.

Particularly, upon determining that the secondary collision of the autonomous vehicle will occur, the autonomous driving controller 100 may secure a safety area A before the secondary collision of the autonomous vehicle with the vehicle and the obstacle will occur by requesting cooperative control of acceleration from a vehicle traveling in front of the autonomous vehicle and requesting cooperative control of deceleration from a vehicle traveling behind the autonomous vehicle.

Accordingly, the autonomous driving controller 10 is configured to provide a steering signal command to the steering controller 120, to provide a braking torque signal command to braking controller 130, and to provide a braking torque signal command to the motor controller 140 so that the autonomous vehicle may be turned to the safety area A after primary collision.

The steering controller 120 is configured to perform steering control depending on a steering intention based on autonomous driving logic of the steering driving controller 100 or a steering intention due to operation of a steering wheel by the driver, and is configured to perform steering control depending on the steering signal command for moving the autonomous vehicle to the safety area A.

The braking controller 130 is configured to perform control of selectively applying braking torque to hydraulic braking devices 132 mounted in respective wheels depending on the braking torque signal command for moving the autonomous vehicle to the safety area A. Particularly, the braking controller 130 may be an integrated electric brake (IEB) controller including an electronic stability control (ESC) system for vehicle stability control.

The motor controller 140 is configured to perform driving torque control and regenerative braking torque control with respect to in-wheel motors (IWMs) 142 mounted in the respective wheels of the autonomous vehicle, and to perform control of selectively applying driving torque to the in-wheel motors 142 mounted in the respective wheels depending on the driving torque signal command for moving the autonomous vehicle to the safety area A.

Therefore, the autonomous driving controller 100 selects a collision candidate vehicle collidable with the autonomous vehicle from among other vehicles around the driving autonomous vehicle, estimates in advance a moving position change of the autonomous vehicle due to collision with the vehicle selected as the collision candidate vehicle, and turns the autonomous vehicle in a direction of avoiding secondary collision of the autonomous vehicle, i.e., to the safety area A, upon determining that that the secondary collision of the autonomous vehicle with a surrounding vehicle or an obstacle will occur depending on the moving position change of the autonomous vehicle due to an actual collision accident with the vehicle selected as the collision candidate vehicle, thereby being capable of easily preventing the secondary collision accident of the autonomous vehicle.

Here, the secondary collision avoidance control of the autonomous vehicle having the above-described configuration will be described in detail.

As shown in FIGS. 3A to 3C, when a vehicle 210 around an autonomous vehicle 20 approaches the autonomous vehicle 200 and thus collision of the autonomous vehicle 200 with with a side part (in FIG. 3A), a rear wheel (in FIG. 3B), or a front wheel (in FIG. 3C) of the autonomous vehicle 200 occurs during driving of the autonomous vehicle 200, the autonomous vehicle 200 may be moved and breach an adjacent lane due to impact caused by the corresponding collision, and thus, secondary collision of the autonomous vehicle with another vehicle 220 may occur.

In order to avoid the secondary collision of the autonomous vehicle 200, the autonomous driving controller 100 selects a collision candidate vehicle collidable with the autonomous vehicle 200 from among other vehicles, based on sensor signals transmitted from the autonomous driving sensor unit.

Here, the sensor signals provided to the autonomous driving controller 100 from the autonomous driving sensor unit may include speeds of the other vehicles, distances between the autonomous vehicle 200 and the other vehicles, heading angle and position information of the other vehicles compared to heading angle and position information of the autonomous vehicle 200.

Therefore, the autonomous driving controller 100 confirms whether or not a vehicle approaching the autonomous vehicle within a designated radius is present based on the sensor signals from the autonomous driving sensor unit, and calculates a collision index indicating a possibility of collision with the vehicle approaching the autonomous vehicle within the designated radius, when it is confirmed that the vehicle approaching the autonomous vehicle within the designated radius is present, and selects the corresponding vehicle as the collision candidate vehicle collidable with the autonomous vehicle 200, when the calculated collision index of the corresponding vehicle exceeds the reference value.

The collision index may be calculated by multiplying a speed of the vehicle approaching the autonomous vehicle 200, a distance between the autonomous vehicle 200 and the vehicle, and an estimated collision area of the vehicle with the autonomous vehicle 200, as stated in Equation 1 below.

$$Collision Index = Speed of Surrounding Vehicle \times Distance between Autonomous Vehicle and Surrounding Vehicle \times Estimated Collision Area \qquad [ Equation l ]$$

When the collision candidate vehicle is selected based on the collision index, the autonomous driving controller 100 determines whether or not collision of the autonomous vehicle with the selected collision candidate vehicle approaching the autonomous vehicle occurs, by receiving a yaw rate signal detected by the yaw rate sensor 115 and a longitudinal acceleration signal and a lateral acceleration signal detected by the acceleration sensor 116 (S100).

For example, upon determining that collision of a front wheel of the autonomous vehicle with the collision candidate vehicle occurs (S100), as shown in FIG. 3C, the autonomous driving controller 100 compares the measurement values of the yaw rate signal, the longitudinal acceleration signal and the lateral acceleration signal with set limit values (S200), and confirms the moving path of the autonomous vehicle through the monitored sensor values, i.e., the yaw rate, the longitudinal acceleration, and the lateral acceleration detected by the autonomous driving sensor unit, upon determining that the measurement values do not exceed the corresponding limit values (S230).

In general, because important inputs to estimate the current behavior and the future moving path of the autonomous vehicle after the collision are the angular velocity of rotation (yaw rate), the longitudinal acceleration, and the lateral acceleration of the autonomous vehicle, and estimation of the moving path of the autonomous vehicle in case of collision, which is estimated before collision, is not accurate, the behavior of the autonomous vehicle may be accurately estimated by receiving yaw rate, longitudinal acceleration, and lateral acceleration information from the yaw rate sensor 115 and the acceleration sensor 166 in real time after occurrence of the collision, and the moving path of the autonomous vehicle may be estimated by increasing accuracy by periodically updating estimation of the moving path, which is estimated before collision.

When the outputs of the yaw rate sensor 115 and the acceleration sensor 116 are within normal ranges, the behavior of the autonomous vehicle may be estimated through the yaw rate sensor 115 and the acceleration sensor 116, but a corresponding sensor output may reach the limit value due to the acceleration output of the autonomous vehicle increased by a great impact, such as collision with another vehicle, or due to sensor failure caused by collision with another vehicle.

In this case, because, the behavior of the autonomous vehicle may not be accurately estimated due to output of the limit value from a sensor, the longitudinal acceleration, lateral acceleration and the yaw rate of the autonomous vehicle after the collision are estimated using the camera 11 and the distance sensor including the RADAR system 13 or the LIDAR system 14 rather than the outputs of the yaw rate sensor 115 and the acceleration sensor 116 (S210).

Consequently, the behavior of the autonomous vehicle is estimated through the measurement values of the yaw rate sensor 115 and the acceleration sensor 116, which are within the normal ranges, before or after occurrence of the collision (S230), and, when the measurement values of the yaw rate sensor 115 and the acceleration sensor 116 are within abnormal ranges, i.e., exceed the respective limit values, the behavior of the autonomous vehicle is estimated using the camera 11, an around view monitor, the distance sensor, and the like, which are mounted in the autonomous vehicle, based on a vehicle dynamics model using the measurement values of the sensors 115 and 116, which are within the normal ranges (S220).

The autonomous driving controller 100 determines whether or not the autonomous vehicle breaches an adjacent lane based on the above-estimated moving path (S300), and allows the autonomous vehicle to maintain a lane in which the autonomous vehicle is traveling through counter steering by the steering controller 120 and partial braking control by the braking controller 130, upon determining that the autonomous vehicle breaches no adjacent lanes (S310).

Here, the autonomous driving controller 100 requests cooperative control from other vehicles located in the lane in which the autonomous vehicle is traveling (S311).

When the autonomous driving controller 100 determines that the speed of the autonomous vehicle in the lane in which the autonomous vehicle is currently traveling is increased through the autonomous driving sensor unit, the autonomous driving controller 100 controls the communication controller 150 to request cooperative control of acceleration from a vehicle traveling in front of the autonomous vehicle in the lane in which the autonomous vehicle is currently traveling.

Further, when the autonomous driving controller 100 determines that the speed of the autonomous vehicle in the lane in which the autonomous vehicle is currently traveling is decreased through the autonomous driving sensor unit, the autonomous driving controller 100 controls the communication controller 150 to request cooperative control of deceleration from a vehicle traveling behind the autonomous vehicle in the lane in which the autonomous vehicle is currently traveling.

Here, in request of cooperative control of acceleration or deceleration from the vehicle traveling in front of or behind the autonomous vehicle, the autonomous driving controller 100 controls the communication controller 150 to request cooperative control of acceleration or deceleration from the vehicle in real time using at least one of vehicle-to-vehicle technology, such as Internet Of Things (IoT) or Vehicle-to-Vehicle (V2V), the RADAR system 13, the LIDAR system 14, ultrasonic waves, the camera 11, or the navigation system 12.

Upon determining that the autonomous vehicle breaches the adjacent lane (S300), the autonomous driving controller 100 estimates secondary collision occurrence probabilities with other vehicles, and notifies related vehicles traveling in the lane breached by the autonomous vehicle of a risk of secondary collision (S320).

That is to say, upon determining that the autonomous vehicle breaches an adjacent lane (S300), the autonomous driving controller 100 provides a collision-related warning to collision-related vehicles traveling in the lane breached by the autonomous vehicle and traveling within a designated radius of the autonomous vehicle using the vehicle-to-vehicle technology, or the like (S330).

Thereafter, the autonomous driving controller 100 confirms positions of additional collision candidate vehicles collidable with the autonomous vehicle, traveling in front of and behind the autonomous vehicle, among other vehicles traveling in the lane breached by the autonomous vehicle (in the same manner as the above-described method of selecting the candidate vehicle using the collision index), and determines whether or not an area in which the autonomous vehicle is capable of avoiding secondary collision, i.e., the safety area A, may be secured by calculating safety distances from the corresponding vehicles based on the measurement values of the sensors 115 and 116 of the autonomous driving sensor unit (S400).

This is to confirm a secondary collision occurrence probability of the autonomous vehicle, in which primary collision has occurred, with another vehicle, and consequently, is to confirm whether or not there is any vehicle in the lane breached by the autonomous vehicle, or to confirm whether or not a sufficient safety distance between the autonomous vehicle and another surrounding vehicle in the lane breached by the autonomous vehicle is secured.

As results of calculation of the safety distances between the autonomous vehicle and the other surrounding vehicles (S400), when the virtual safety area A is formed by securing the safety distances between the autonomous vehicle and the additional collision candidate vehicles, the autonomous driving controller 100 requests cooperative control from the additional collision candidate vehicles so that the safety area A may be maintained (S410).

That is, as shown in FIG. 5, the autonomous driving controller 100 calculates the safety distances between the autonomous vehicle and the collision candidate vehicles in front of and behind the autonomous vehicle (S411), assuming a situation in which the autonomous vehicle 200 enters a lane in which the safety area A is formed by the primary collision (in FIG. 6), and determines whether or not the additional collision candidate vehicles in front of and behind the autonomous vehicle are located at the boundary of the safety area A (S412).

Upon determining that any additional collision candidate vehicle is located at the front boundary region of the safety area A, the autonomous driving controller 100 requests cooperative control of acceleration from the additional collision candidate vehicle located at the front boundary of the safety area A in front of the autonomous vehicle in the lane breached by the autonomous vehicle using the vehicle-to-vehicle technology, or the like (S413).

Further, upon determining that any additional collision candidate vehicle is located at the rear boundary region of the safety area A, the autonomous driving controller 100 requests cooperative control of deceleration from the additional collision candidate vehicle located at the rear boundary of the safety area A behind the autonomous vehicle in the lane breached by the autonomous vehicle using the vehicle-to-vehicle technology, or the like (S414).

Upon determining that the safety area A is secured, i.e., safety of the autonomous vehicle in the lane breached by the autonomous vehicle is secured, by requesting cooperative control of acceleration and deceleration (S415), the autonomous driving controller 100 controls the steering, the driving torque and the braking torque of the autonomous vehicle through the steering controller 120, the braking controller 130 and the motor controller 140 so as to move the autonomous vehicle toward the safety area A (S420).

As results of calculation of the safety distances between the autonomous vehicle and the surrounding vehicles (S400), upon determining that the autonomous vehicle and the additional collision candidate vehicles in front of and/or behind the autonomous vehicle are not secured, the autonomous driving controller 100 requests cooperative control from the additional collision candidate vehicles so that the safety area A may be secured (S430).

That is to say, because secondary collision occurs when the autonomous vehicle 200 enters the lane in which the safety area A is not secured, as shown in FIG. 8, the autonomous driving controller 100 first calculates safety distances from other vehicles 220, i.e., the additional collision candidate vehicles, in the lane breached by the autonomous vehicle 200, in which the safety area A is not secured (S431), and controls the communication controller 150 to request cooperative control to the corresponding vehicles using the vehicle-to-vehicle technology, or the like, as shown in FIG. 7.

For example, in order to secure the safety area A, the autonomous controller 100 requests cooperative control of acceleration from a vehicle traveling in front of the autonomous vehicle in the lane breached by the autonomous vehicle (S432), and requests cooperative control of deceleration from a vehicle traveling behind the autonomous vehicle in the lane breached by the autonomous vehicle (S433).

Here, upon determining that cooperative control of the vehicle traveling in front of the autonomous vehicle in the lane breached by the autonomous vehicle is enabled but cooperative control of the vehicle traveling behind the autonomous vehicle in the lane breached by the autonomous vehicle is not enabled (S434), the autonomous driving controller 10 determines whether or not the safety area A is changeable (S435).

Upon determining that the safety area A is changeable forwards by execution of cooperative control of acceleration from the vehicle 220 traveling in front of the autonomous vehicle 200 in the lane breached by the autonomous vehicle 200 (i.e., acceleration of the vehicle 220 in the direction of an arrow of FIG. 9) (Yes in S435), the autonomous driving controller 100 issues a steering signal command for the autonomous vehicle, and controls the driving torque and the braking torque of the autonomous vehicle to move the autonomous vehicle to the changed safety area A′ through steering and acceleration (S436).

On the contrary, although not shown in the drawings, upon determining that cooperative control of the vehicle traveling behind the autonomous vehicle in the lane breached by the autonomous vehicle is enabled but cooperative control from the vehicle traveling in front of the autonomous vehicle in the lane breached by the autonomous vehicle is not enabled, the autonomous driving controller 100 may determine whether or not the safety area A is changeable, may selectively change the safety area A rearwards, and may control the vehicle to be moved to the changed safety area A′.

Upon determining that the safety area A is not changeable forwards depending on non-execution of cooperative control (No in S435), the autonomous driving controller 100 issues a steering signal command for the autonomous vehicle, and controls the driving torque and the braking torque of the autonomous vehicle to move the autonomous vehicle through steering and deceleration while confirming the relative position of the vehicle traveling behind the autonomous vehicle (S437).

After control of the autonomous vehicle to move toward the changed safety area A′ or control of the autonomous vehicle to move through steering and deceleration while confirming the relative position of the autonomous vehicle to the vehicle traveling behind the autonomous vehicle, upon determining that no secondary collision of the autonomous vehicle with the vehicle traveling in front of or behind the autonomous vehicle occurs (Yes in S438), secondary collision avoidance control is terminated.

Although, in the above-described secondary collision avoidance control method in which respective operations are sequentially performed, collision of a front wheel of the autonomous vehicle with another vehicle has been described, as shown in FIG. 3C, such a collision is only one example, and collision of the side part or a rear wheel of the autonomous vehicle with another vehicle, as shown in FIG. 3A or 3B, may be also avoided by moving the autonomous vehicle to the safety area A through the same collision avoidance control method.

In the secondary collision avoidance control method according to the present disclosure, in order to prevent occurrence of secondary collision of the autonomous vehicle after side collision with a surrounding vehicle during autonomous driving, surrounding vehicles traveling on a moving path in a lane breached by the autonomous vehicle are notified of the risk of secondary collision, and a safety area is secured by inducing changes in the traveling positions of the surrounding vehicles on the moving path of the autonomous vehicle by allowing the surrounding vehicles to be accelerated or decelerated, thereby being capable of moving the autonomous vehicle to the secured safety area without secondary collision occurrence.

Thereby, in the secondary collision avoidance control method according to the present disclosure, secondary collision of the autonomous vehicle is prevented, and thus injury to a driver due to collision may be minimized.

As is apparent from the above description, in a secondary collision avoidance control method of an autonomous vehicle according to the present disclosure, in order to prevent occurrence of secondary collision of the autonomous vehicle after side collision with a surrounding vehicle during autonomous driving, surrounding vehicles traveling on a moving path in a lane breached by the autonomous vehicle are notified of the risk of secondary collision, and a safety area is secured by inducing changes in the traveling positions of the surrounding vehicles on the moving path of the autonomous vehicle by allowing the surrounding vehicles to be accelerated or decelerated, thereby being capable of moving the autonomous vehicle to the secured safety area without secondary collision occurrence.

Thereby, in the secondary collision avoidance control method according to the present disclosure, secondary collision of the autonomous vehicle is prevented, and thus, injury to a driver due to collision may be minimized.

The disclosure has been described in detail with reference to preferred embodiments thereof. However, it should be apparent to those skilled in the art that various substitutions, changes and modifications which are not exemplified herein but are still within the spirit and scope of the present disclosure may be made. Therefore, the scope of the present disclosure is defined not by the detailed description, but by the claims and their equivalents, and all variations within the scope of the claims and their equivalents are to be construed as being included in the present disclosure.

What is claimed is:

1. A secondary collision avoidance control method of an autonomous vehicle, the secondary collision avoidance control method comprising:
selecting, by an autonomous driving controller, a collision candidate vehicle configured to be collidable with the autonomous vehicle from among other vehicles based on a plurality of sensor signals from an autonomous driving sensor unit;
estimating, by the autonomous driving controller, a moving path of the autonomous vehicle using the sensor signals detected from the autonomous driving sensor unit, upon determining that the collision candidate vehicle approaches and collision of the autonomous vehicle with the collision candidate vehicle occurs;
estimating, by the autonomous driving controller, secondary collision occurrence probabilities of the autonomous vehicle with the other vehicles, upon determining that the autonomous vehicle breaches an adjacent lane based on the estimated moving path;
confirming, by the autonomous driving controller, positions of additional collision candidate vehicles traveling in front of or behind the autonomous vehicle and configured to be collidable with the autonomous vehicle among the other vehicles traveling in the lane breached by the autonomous vehicle, and calculating safety distances between the autonomous vehicle and the additional collision candidate vehicles based on the sensor signals from the autonomous sensor unit; and
controlling, by the autonomous driving controller, steering, driving torque, and braking torque of the autonomous vehicle so as to move the autonomous vehicle to a virtual safety area, when the safety area is formed by securing the safety distances between the autonomous vehicle and the additional collision candidate vehicles traveling in front of or behind the autonomous vehicle.

2. The secondary collision avoidance control method of claim 1, wherein, in estimating, by the autonomous driving controller, the moving path of the autonomous vehicle, the autonomous driving controller compares measurement values of the sensor signals with set limit values, and estimates the moving path of the autonomous vehicle through the sensor signals comprising a longitudinal acceleration, a lateral acceleration, and a yaw rate detected by the autonomous driving sensor unit. upon determining that the collision of the autonomous vehicle with the candidate vehicle occurs.

3. The secondary collision avoidance control method of claim 2, wherein, in estimating, by the autonomous driving controller, the moving path of the autonomous vehicle, the autonomous driving controller estimates relative positions of the autonomous vehicle to the other vehicles after occurrence of primary collision through sensor signals detected by a camera, an around view monitor, and a distance sensor other than an acceleration sensor and a yaw rate sensor configured to detect the longitudinal acceleration, the lateral acceleration, and the yaw rate, upon determining that the measurement values of the sensor signals exceed the limit values.

4. The secondary collision avoidance control method of claim 1, wherein, in estimating, by the autonomous driving controller, the secondary collision occurrence probabilities of the autonomous vehicle with the other vehicles, the autonomous driving controller requests cooperative control from other vehicles traveling in a lane, in which the autonomous vehicle is currently traveling, upon determining that the autonomous vehicle breaches no adjacent lane based on the estimated moving path.

5. The secondary collision avoidance control method of claim 4, wherein, in estimating, by the autonomous driving controller, the secondary collision occurrence probabilities of the autonomous vehicle with the other vehicles, the autonomous driving controller requests cooperative control of acceleration from a vehicle traveling in front of the autonomous vehicle in the lane, in which the autonomous vehicle is currently traveling, upon determining that a speed of the autonomous vehicle is increased through the autonomous driving sensor unit, and requests cooperative control of acceleration from a vehicle traveling behind the autonomous vehicle in the lane, in which the autonomous vehicle is currently traveling, upon determining that the speed of the autonomous vehicle is decreased through the autonomous driving sensor unit.

6. The secondary collision avoidance control method of claim 4, wherein, in estimating, by the autonomous driving controller, the secondary collision occurrence probabilities of the autonomous vehicle with the other vehicles, the autonomous driving controller requests cooperative control from the other vehicles in real time using at least one of Internet Of Things (IoT), Vehicle-to-Vehicle (V2V) communication, a RADAR system, a LIDAR system, ultrasonic waves, a camera, or a navigation system.

7. The secondary collision avoidance control method of claim 1, wherein, in controlling, by the autonomous driving controller, the steering, the driving torque, and the braking torque of the autonomous vehicle so as to move the autonomous vehicle to the safety area, the autonomous driving controller requests cooperative control of acceleration from a vehicle traveling in front of the autonomous vehicle in the lane breached by the autonomous vehicle, and requests cooperative control of deceleration from a vehicle traveling behind the autonomous vehicle in the lane breached by the autonomous vehicle, upon determining that the other vehicles are located at front and rear boundary regions of the safety area.

8. The secondary collision avoidance control method of claim 7, wherein, in controlling, by the autonomous driving controller, the steering, the driving torque, and the braking torque of the autonomous vehicle so as to move the autonomous vehicle to the safety area, the autonomous driving controller requests cooperative control from the other vehicles in real time using at least one of Internet Of Things (IoT), Vehicle-to-Vehicle (V2V) communication, a RADAR system, a LIDAR system, ultrasonic waves, a camera, or a navigation system.

9. The secondary collision avoidance control method of claim 1, wherein, in controlling, by the autonomous driving controller, the steering, the driving torque, and the braking torque of the autonomous vehicle so as to move the autonomous vehicle to the safety area, the autonomous driving controller requests cooperative control of acceleration from a vehicle traveling in front of the autonomous vehicle in the lane breached by the autonomous vehicle, and requests cooperative control of deceleration from a vehicle traveling behind the autonomous vehicle in the lane breached by the autonomous vehicle before moving the autonomous vehicle to the safety area, upon determining that the safety distances between the autonomous vehicle and the additional collision candidate vehicles are not secured.

10. The secondary collision avoidance control method of claim 9, wherein, in controlling, by the autonomous driving controller, the steering, the driving torque, and the braking torque of the autonomous vehicle so as to move the autonomous vehicle to the safety area, the autonomous driving controller selectively changes the safety area, upon determining that the cooperative control from the vehicle traveling behind the autonomous vehicle in the lane breached by the autonomous vehicle is not enabled.

11. The secondary collision avoidance control method of claim 10, wherein, in controlling, by the autonomous driving controller, the steering, the driving torque, and the braking torque of the autonomous vehicle so as to move the autonomous vehicle to the safety area, the autonomous driving controller changes the safety area to move the safety area forwards.

12. The secondary collision avoidance control method of claim 9, wherein, in controlling, by the autonomous driving controller, the steering, the driving torque, and the braking torque of the autonomous vehicle so as to move the autonomous vehicle to the safety area, the autonomous driving controller selectively changes the safety area, upon determining that the cooperative control of deceleration from the vehicle traveling in front of the autonomous vehicle in the lane breached by the autonomous vehicle is not enabled.

13. The secondary collision avoidance control method of claim 12, wherein, in controlling, by the autonomous driving controller, the steering, the driving torque, and the braking torque of the autonomous vehicle so as to move the autonomous vehicle to the safety area, the autonomous driving controller changes the safety area to move the safety area rearwards.

14. A vehicle comprising the autonomous driving controller for carrying out the secondary collision avoidance control method of claim 1.

15. An autonomous vehicle comprising the autonomous driving controller for carrying out the secondary collision avoidance control method of claim 1.

16. A non-transitory computer readable medium containing program instructions executed by a processor, the computer readable medium comprising:
program instructions that select a collision candidate vehicle configured to be collidable with an autonomous vehicle from among other vehicles based on a plurality of sensor signals from an autonomous driving sensor unit;
program instructions that estimate a moving path of the autonomous vehicle using the sensor signals detected from the autonomous driving sensor unit, upon determining that the collision candidate vehicle approaches and collision of the autonomous vehicle with the collision candidate vehicle occurs;
program instructions that estimate secondary collision occurrence probabilities of the autonomous vehicle with the other vehicles, upon determining that the autonomous vehicle breaches an adjacent lane based on the estimated moving path;
program instructions that confirm positions of additional collision candidate vehicles traveling in front of or behind the autonomous vehicle and configured to be collidable with the autonomous vehicle among the other vehicles traveling in the lane breached by the autonomous vehicle, and calculating safety distances between the autonomous vehicle and the additional collision candidate vehicles based on the sensor signals from the autonomous sensor unit; and
program instructions that control steering, driving torque, and braking torque of the autonomous vehicle so as to move the autonomous vehicle to a virtual safety area, when the safety area is formed by securing the safety distances between the autonomous vehicle and the additional collision candidate vehicles traveling in front of or behind the autonomous vehicle.
